(19) United States
(12) Patent Application Publication
(10) Pub. No.: US 2010/0058186 A1
(43) Pub. Date: Mar. 4, 2010

(54) REPRODUCING APPARATUS AND REPRODUCING METHOD

(75) Inventors: Motoyuki TAKAI, Tokyo (JP); Shinya FUKUTA, Saitama (JP); Takashi KINOUCHI, Tokyo (JP); Takeshi Ozawa, Kanagawa (JP); Akira INOUE, Tokyo (JP); Shusuke TAKAHASHI, Chiba (JP); Manabu Uchino, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/502,332

(22) Filed: Jul. 14, 2009

(30) Foreign Application Priority Data
Aug. 28, 2008 (JP) 2008-219061

(51) Int. Cl. G06F 17/30; G06F 3/048; G06N 5/02

(52) U.S. Cl. 715/716; 700/94; 707/104.1; 706/54; 707/E17.102; 707/E17.047

(57) ABSTRACT

A reproducing apparatus includes a storage section, a judgment section, an analysis section, a classification section, an input section, and a reproduction section. The storage section stores a plurality of pieces of audio data. The judgment section judges, based on a length of each piece of audio data stored in the storage section, an analysis time interval for each piece of audio data. The analysis section analyzes the audio data in the analysis time interval judged by the judgment section. The classification section classifies the respective pieces of audio data into a plurality of predetermined classification items based on results of the analysis. The input section causes a user to select the classification item of the audio data to be reproduced. The reproduction section reproduces the audio data belonging to the classification item selected by the input section from a reproduction start point within the analysis time interval.

### BACKGROUND OF THE INVENTION

1. Field of the Invention

The present invention relates to a reproducing apparatus and a reproducing method that are capable of analyzing and reproducing audio data, for example.

2. Description of the Related Art

As the volume of contents that a user can access becomes huge, selection of a specific content becomes bothersome for the user, and therefore a style of listening to music pieces at random from all pieces on hand has becomes popular. However, in the case of listening to music pieces at random from all pieces on hand, there arises a problem that music tones or atmospheres of the music pieces are also selected at random. For example, in a case where a user listens to music for the purpose of relaxation, in general, it is desirable that only quiet pieces be reproduced successively.

For that reason, there is proposed a system for, after analyzing music tones of contents and classifying the contents into a plurality of groups based on similarity of the music tones, reproducing at random contents selected from a predetermined group. With this system, the user can continuously reproduce contents of an even music tone.

Examples of the system include Omakase Channel (registered trademark) of Sony (registered trademark) NetJuke (registered trademark), VAIO (registered trademark) MusicBox (registered trademark), and Music Sommelier (registered trademark) of Panasonic (registered trademark), all of which are used in personal computers or stationary electronic apparatuses. Further, there are potable devices having a similar function (Sony Ericsson (registered trademark): W595 SensMe (registered trademark)), in which analysis of music tones itself is performed by personal computers or the like (see, for example, Japanese Patent Application Laid-open No. 2008-65905; paragraph [0005], FIG. 2).

### SUMMARY OF THE INVENTION

However, in a case where analysis and classification of music tones of contents such as music pieces are performed by portable devices, there arises a problem that calculation loads on CPUs (Central Processing Units) of the portable devices are increased. In addition, batteries of the portable devices have the limit in capacity. Therefore, in the case where the analysis and the classification of music tones of contents are performed by the portable devices, there is a demand for analysis on music tones of contents as efficiently as possible.

Further, if the classification result is different from an impression of a user on a music piece that the user has actually listened to in accordance with the classification result, the user feels uncomfortable with the analysis result.

In view of the above-mentioned circumstances, there is a need for a reproducing apparatus and a reproducing method that are capable of analyzing audio data efficiently and preventing a user from feeling uncomfortable with the analysis result.

According to an embodiment of the present invention, there is provided a reproducing apparatus including a storage section, a judgment section, an analysis section, a classification section, an input section, and a reproduction section. The storage section stores a plurality of pieces of audio data. The judgment section judges, based on a length of each of the pieces of audio data stored in the storage section, an analysis time interval for each of the pieces of audio data. The analysis section analyzes the audio data in the analysis time interval judged by the judgment section. The classification section classifies the respective pieces of audio data into a plurality of predetermined classification items based on results of the analysis. The input section causes a user to select the classification item of the audio data to be reproduced. The reproduction section reproduces the audio data belonging to the classification item selected by the input section from a reproduction start point within the analysis time interval.

In the embodiment of the present invention, because the analysis time interval for the audio data is judged based on the length of the audio data and the audio data in the analysis time interval judged by the judgment section is analyzed, a calculation load on the reproducing apparatus can be reduced and the analysis can be efficiently performed. Because the audio data that belongs to the classification item selected by using the input section is reproduced from the reproduction start point within the analysis time interval, the reproduction start point is included in the analysis time interval, with the result that it is possible to prevent a user from feeling uncomfortable with the analysis result.

When the judgment section judges that the length of the audio data is equal to or larger than a predetermined value, the judgment section may judge part of the length of the audio data as the analysis time interval.

Accordingly, when the length of the audio data is equal to or larger than the predetermined value, it is possible to reduce the calculation load on the reproducing apparatus with the part of the length of the audio data set as the analysis time interval.

The reproduction start point may be equal to an analysis start point of the analysis time interval.

Accordingly, it is possible to prevent the user from feeling uncomfortable with the analysis result more reliably at a time of reproducing the audio data.

The reproducing apparatus may further include a display section to display a guide screen for prompting a user to analyze unanalyzed audio data stored in the storage section.

Accordingly, it is possible to prompt the user to analyze the unanalyzed audio data.

The reproducing apparatus may further include a control section to perform control so that processing performed by the judgment section, the analysis section, and the classification section are successively performed on the plurality of pieces of audio data stored in the storage section.

Accordingly, the plurality of pieces of audio data can be successively analyzed.

The control section may perform control so that a remaining time of the processing on all the pieces of audio data stored in the storage section is calculated and displayed.

Accordingly, the user can know when the processing are finished during the analysis of the audio data.

The analysis section may analyze a music tone of the audio data.

Accordingly, it is possible to analyze the music tone of the audio data and classify the pieces of audio data in accordance with the analysis result.

According to another embodiment of the present invention, there is provided a reproducing method including storing a plurality of pieces of audio data. Based on a length of each of the pieces of audio data, an analysis time interval for each of the pieces of audio data is judged. The audio data in the judged analysis time interval is analyzed. The respective pieces of audio data are classified into a plurality of predetermined classification items based on results of the analysis. The classification item of the audio data to be reproduced is selected by a user. The audio data belonging to the selected classification item is reproduced from a reproduction start point within the analysis time interval.

In the embodiment of the present invention, because the analysis time interval for the audio data is judged based on the length of the audio data and the audio data in the judged analysis time interval is analyzed, a calculation load can be reduced and the analysis can be efficiently performed. Because the audio data that belongs to the classification item selected by the user is reproduced from the reproduction start point within the analysis time interval, the reproduction start point is included in the analysis time interval, with the result that it is possible to prevent the user from feeling uncomfortable with the analysis result.

According to another embodiment of the present invention, there is provided a reproducing apparatus including a storage means, a judgment means, an analysis means, a classification means, an input means, and a reproduction means. The storage means stores a plurality of pieces of audio data. The judgment means judges, based on a length of each of the pieces of audio data stored in the storage means, an analysis time interval for each of the pieces of audio data. The analysis means analyzes the audio data in the analysis time interval judged by the judgment means. The classification means classifies the respective pieces of audio data into a plurality of predetermined classification items based on results of the analysis. The input means causes a user to select the classification item of the audio data to be reproduced. The reproduction means reproduces the audio data belonging to the classification item selected by the input means from a reproduction start point within the analysis time interval.

According to another embodiment of the present invention, there is provided a recording medium recording a program for executing: storing a plurality of pieces of audio data; judging, based on a length of each of the pieces of audio data, an analysis time interval for each of the pieces of audio data; analyzing the audio data in the judged analysis time interval; classifying the respective pieces of audio data into a plurality of predetermined classification items based on results of the analysis; causing a user to select the classification item of the audio data to be reproduced; and reproducing the audio data belonging to the selected classification item from a reproduction start point within the analysis time interval.

As described above, according to the embodiments of the present invention, it is possible to efficiently analyze the audio data and to prevent the user from feeling uncomfortable with the analysis result.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a block diagram showing a configuration of a reproducing apparatus according to an embodiment of the present invention;

FIG. 2 is a block diagram showing a functional configuration at a time of analysis and classification in the reproducing apparatus;

FIG. 3 is a diagram showing a configuration of a content list in a content database of FIG. 2;

FIG. 4 is a diagram showing a configuration of a group list in a content management database of FIG. 2;

FIG. 5 is a table of analytical formula data, which is contained in a ROM;

FIG. 6 is a graph showing a relationship between a length of a content and a reproduction time;

FIG. 7 is a flowchart of an analysis and classification (registration) operation of the reproducing apparatus;

FIG. 8 is a diagram showing a state where a message is displayed on a display screen;

FIG. 9 is a diagram showing the number of unanalyzed contents and a remaining time;

FIG. 10 is a block diagram showing a functional configuration at a time of reproduction in the reproducing apparatus; and

FIG. 11 is a flowchart of a content data reproduction operation of the reproducing apparatus.

### DESCRIPTION OF PREFERRED EMBODIMENTS

Hereinafter, an embodiment of the present invention will be described with reference to the drawings.

### (Configuration of Reproducing Apparatus)

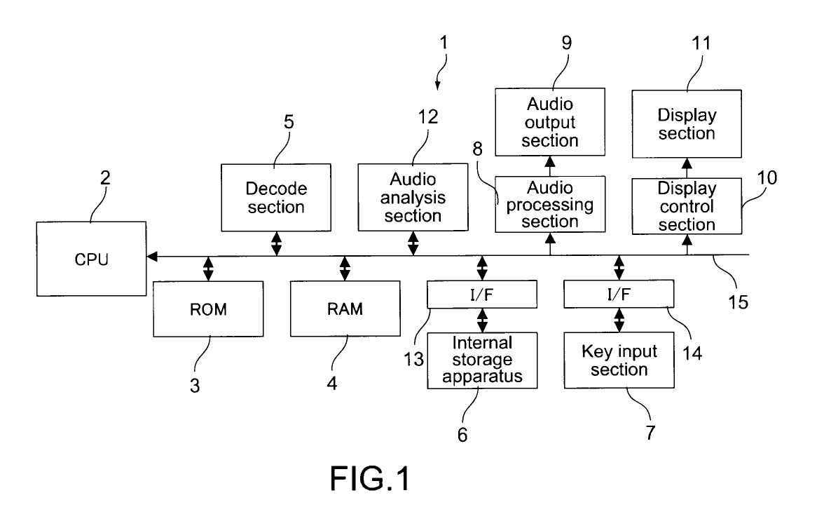

FIG. 1 is a block diagram showing a hardware configuration of a reproducing apparatus according to an embodiment of the present invention.

A reproducing apparatus 1 is, for example, a portable electronic apparatus that is capable of recording and reproducing contents such as audio files. The reproducing apparatus 1 includes a CPU (Central Processing Unit) 2, a ROM (Read Only Memory) 3, a RAM (Random Access Memory) 4, a decode section 5, an internal storage apparatus 6, a key input section 7, an audio processing section 8, an audio output section 9, a display control section 10, a display section 11, and an audio analysis section 12.

The CPU 2 controls the respective sections and processes content data such as music. The ROM 3 stores various programs and analytical formula data used for analysis of contents (for example, analysis of music tones), the analysis being described later. The RAM 4 serves as a work space used when content data is analyzed, for example.

The decode section 5 decodes content data such as music that is encoded in an MP3 (MPEG Audio Layer-3) format or the like.

The internal storage apparatus 6 is connected to a bus 15 via an interface (I/F) 13. The internal storage apparatus 6 stores a content database for managing audio files, for example. The content database contains, for example, a plurality of audio files. It should be noted that the audio files refer to data containing audio as information and, for example, general data including music pieces, human voices, and other sounds. The internal storage apparatus 6 can exchange data and the like with the respective sections via the interface (I/F) 13 and the bus 15.

The key input section 7 is, for example, connected to the bus 15 via an interface (I/F) 14. The key input section 7 includes a button for switching on/off of a power source, a volume adjustment button for adjusting a volume during reproduction, a button for starting reproduction, a button for stopping reproduction, a button for switching and selecting various functions, and the like.

For example, when a button for reproducing an audio file is selected in response to an operation by a user on the key input section 7, the audio processing section 8 acquires an audio file stored in the internal storage apparatus 6 and processes audio data. The audio output section 9 outputs an audible sound in accordance with an audio signal transmitted from the audio processing section 8.

The display control section 10 acquires, for example, image data (image data of a jacket or the like) that is a piece of attribute information contained in an audio file, performs image processing, and outputs an image signal to the display section 11. The display section 11 displays an image in accordance with the image signal transmitted from the display control section 10.

The audio analysis section 12 analyzes audio files, as described below, so as to classify individual audio files into groups (channels) serving as classification items corresponding to music tones and the like.

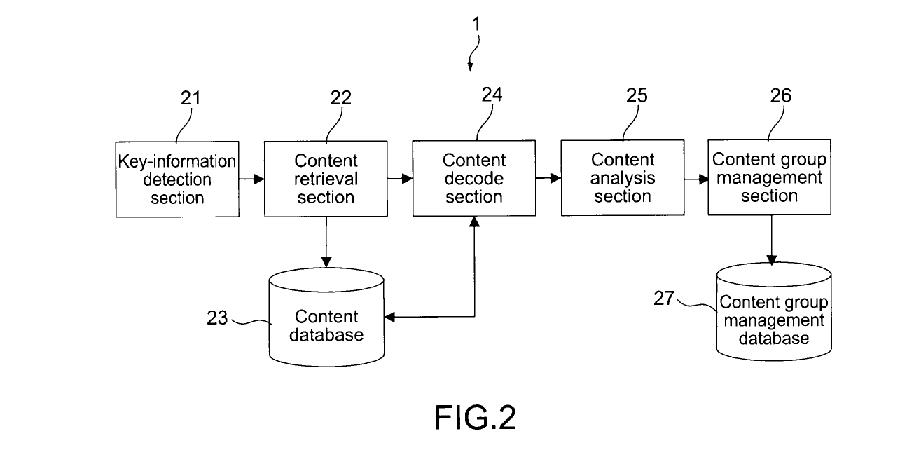

FIG. 2 is a block diagram showing a functional configuration at a time of analysis and classification in the reproducing apparatus 1.

The reproducing apparatus 1 includes a key-information detection section 21, a content retrieval section 22, a content database 23, a content decode section 24, a content analysis section 25, a content group management section 26, and a content group management database 27. It should be noted that “content” refers to an audio file, image data, or the like.

The key-information detection section 21 detects key information in response to an operation performed by a user on a predetermined button of the key input section 7, for example, and transmits the key information to the content retrieval section 22. Specifically, when the user presses a predetermined button for causing the audio analysis section 12 to analyze an unanalyzed content, the key-information detection section 21 detects the key information and transmits it to the content retrieval section 22.

Upon receiving the key information, the content retrieval section 22 retrieves unanalyzed contents from contents contained in the content database 23. The content database 23 contains a plurality of audio files or the like. The content retrieval section 22 notifies the content decode section 24 of a retrieval result of the unanalyzed contents.

The content decode section 24 acquires the retrieval result transmitted from the content retrieval section 22, for example. In accordance with the retrieval result, the content decode section 24 reads unanalyzed content data from the content database 23 and decodes it using the decode section 5.

The content analysis section 25 analyzes the decoded content data. The analysis includes a music tone analysis for an audio file as a content, for example. As described below, the content analysis section 25 calculates an analysis time interval in which a music tone is analyzed (analysis start position and analysis end position) to analyze an audio file in the analysis time interval, and calculates a reproduction start position.

The analysis of music tones includes a frequent analysis processing in which an audio file is frequency-analyzed, and a characteristic amount calculation processing of calculating a characteristic amount obtained by converting a characteristic of audio data into numbers. In other words, the content analysis section 25 executes the frequent analysis processing with respect to an audio file. Accordingly, the content analysis section 25 extracts energy values for each frequency band corresponding to each of twelve scales of one octave in a range from a predetermined analysis start position to a predetermined analysis end position of the audio file along a time axis of the music. Thus, upon obtaining the energy values for each frequency band within a predetermined analysis time interval of audio data, the content analysis section 25 then performs the characteristic amount calculation processing based on the energy values for each frequency band. The characteristic amount is a parameter value obtained by using information such as a tempo of music, fluctuation of a tone, musical scales, and a rhythm. As a result of the analysis, the content analysis section 25 obtains the characteristic amount (parameter value) and transmits it to the content group management section 26.

The content group management section 26 judges a group of a music tone to which the audio file is to belong based on the characteristic amount and registers the correspondence between the audio file and the group in the content group management database 27.

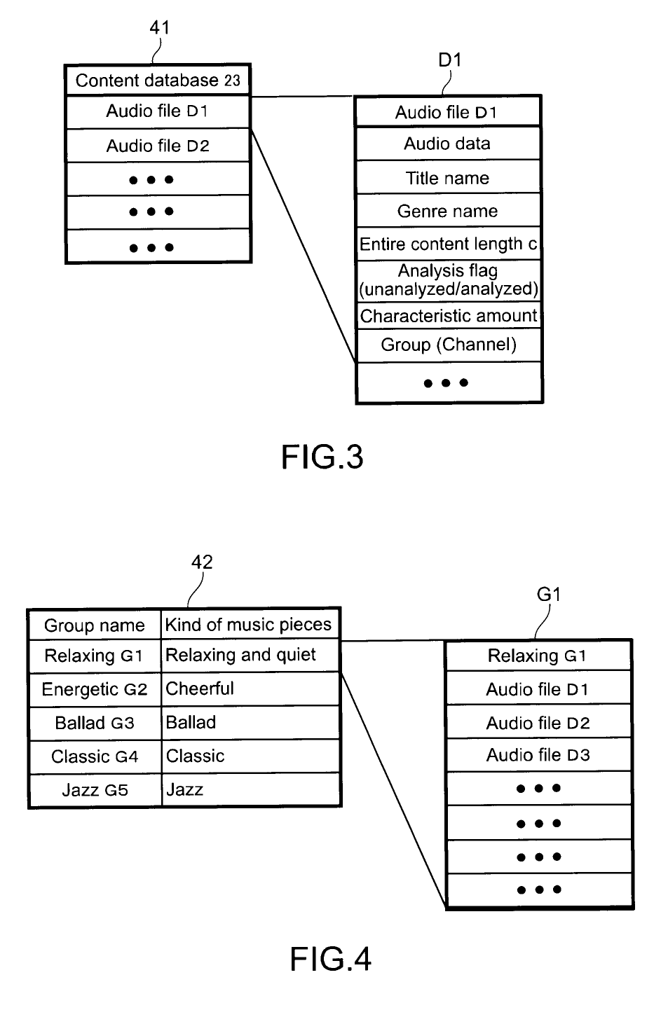

FIG. 3 is a diagram showing a configuration of a content list contained in the content database 23 of FIG. 2.

The content database 23 contains a content list 41 that includes a plurality of audio files D1, D2, and the like. For example, the audio file D1 contains attribute information such as “analysis flag”, “characteristic amount”, and “group”, in addition to “audio data” as audio data, “title name” of a music piece, “genre name” to which the music piece belongs, and “entire content length c” that is a length during which the music piece can be reproduced. The “analysis flag” is, for example, a flag showing whether the audio file D1 has been analyzed. The “characteristic amount” is, for example, a parameter value that is obtained as a result of the analysis. The characteristic amount is used for the judgment of groups to which the audio files D1 and D2 belong, for example. The “group” indicates a group of a music tone to which the audio file D1 or the like belongs.

FIG. 4 is a diagram showing a configuration of a group list contained in the content group management database 27 of FIG. 2.

The content group management database 27 contains a group list 42. The group list 42 is a list of music-tone groups that are classified in accordance with the characteristics amounts. Those groups are Relaxing G1, Energetic G2, Ballad G3, Classic G4, and Jazz G5, for example. Relaxing G1 is a group of quiet pieces that make listeners feel relaxed. Energetic G2 is a group of cheerful pieces. Ballad G3 is a group of ballad-like pieces. Classic G4 is a group of classic pieces. Jazz G5 is a group of jazzy pieces.

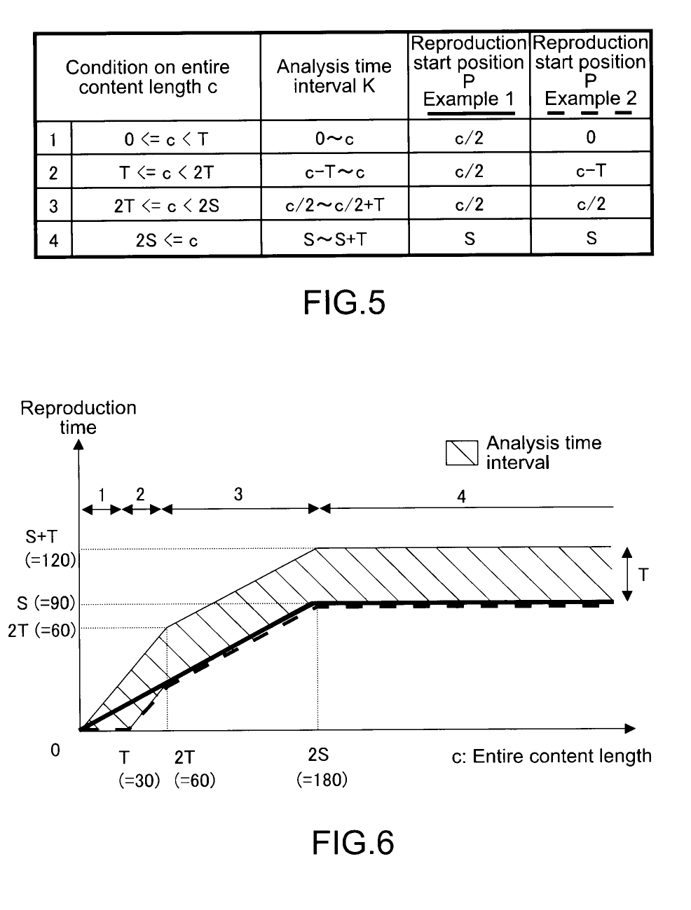

FIG. 5 is a table of analytical formula data, which is contained in the ROM 3.

The table of analytical formula data is a table in which pieces of data indicating a relationship between an entire content length c, an analysis time interval K, and a reproduction start position P are registered. In accordance with four cases (1) to (4) of the entire content length c, the analysis time interval K and the reproduction start position P are stored in the table of analytical formula data.

(1) When the entire content length c satisfies 0≦c<T, the analysis time interval K of a content is 0 to c, and the reproduction start position P thereof is c/2. In this case, T represents a fixed analysis length (fixed value that is set to a predetermined value) and is set to 30 seconds, for example.

(2) When the entire content length c satisfies T≦c<2T, the analysis time interval K of a content is c−T to c, and the reproduction start position P thereof is c/2.

(3) When the entire content length c satisfies 2T≦c<2S, the analysis time interval K of a content is c/2 to c/2+T, and the reproduction start position P thereof is c/2.

(4) When the entire content length c satisfies 2S≦c, the analysis time interval K of a content is S to S+T, and the reproduction start position P thereof is S. In this case, S represents a fixed chorus position (fixed value that is set to a predetermined value) and is set to 90 seconds, for example.

As shown in the table of analytical formula data, the analysis time interval K and the reproduction start position P are associated with each other and the analysis time interval K includes the reproduction start position P. In other words, the reproduction start position P is located between the analysis start position and the analysis end position of the analysis time interval K.

FIG. 6 is a graph showing a relationship between the entire content length c and the analysis time interval K.

Here, the vertical axis represents a reproduction time as an elapsed time after reproduction start, and the horizontal axis represents the entire content length c. The analysis time interval K is indicated as a shaded area. In a case of a music piece of 3 minutes or more, for example, the fixed chorus position S of the audio file D1 or the like is estimated to be a position of 90 seconds or later from the reproduction start of the music piece.

It should be noted that the fixed chorus position S is a position that is uniquely determined by statistically investigating from where a chorus is generally started in a music piece. For example, in the case of the piece of 3 minutes or more, the chorus is often started at the position of 90 seconds from the reproduction start. For that reason, in this embodiment, in a case where the entire content length c is 2S (3 minutes, S=90 seconds) or more, the position of 90 seconds from the reproduction start is adopted as the analysis start position and reproduction start position.

### (Analysis and Classification Operation for Audio File Performed by Reproducing Apparatus 1)

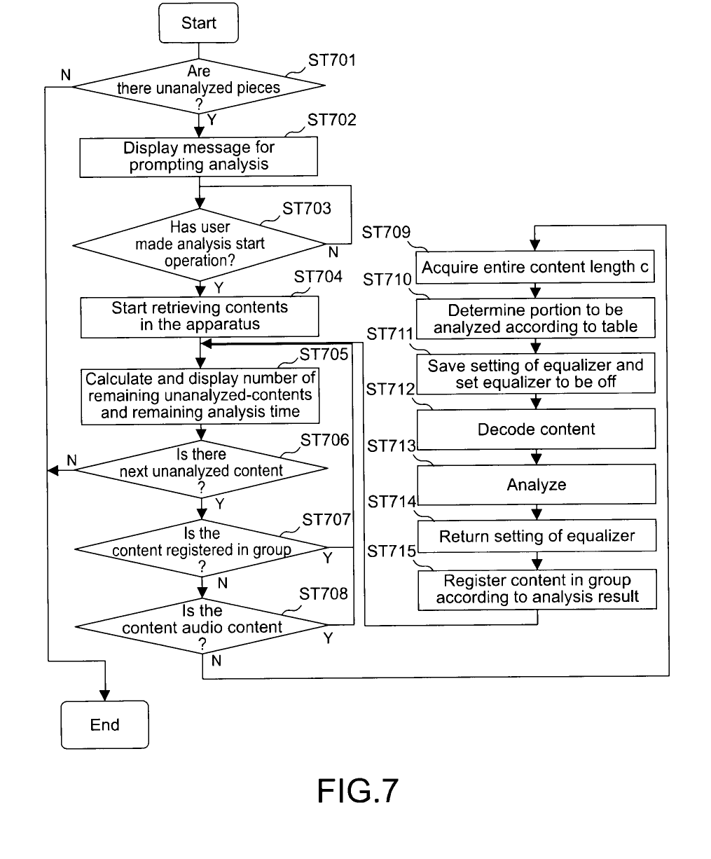

FIG. 7 is a flowchart showing an analysis and classification (registration) operation performed by the reproducing apparatus 1.

The content retrieval section 22 judges whether an unanalyzed content is stored (ST701). Specifically, the content retrieval section 22 judges whether the audio file D1 has already been analyzed, based on information of the analysis flag of the audio file D1 that is stored in the internal storage apparatus 6, the audio file D1 being shown in FIG. 3.

When no unanalyzed contents are present (NO in ST701), the content retrieval section 22 terminates the analysis and classification processing. When an unanalyzed content is present (YES in ST701), the content retrieval section 22 causes the display section 11 to display a message for prompting a user to perform an analysis (ST702).

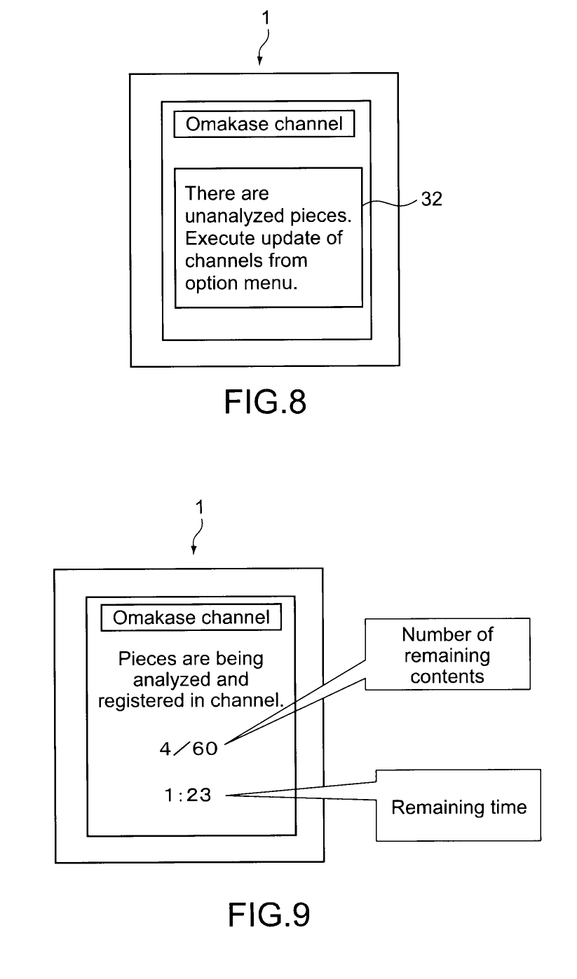

FIG. 8 is a diagram showing an example of the message for prompting a user to perform an analysis.

In this example, a message 32 “There are unanalyzed pieces. Execute update of channels from the option menu.” is used.

The description returns to the description of the operation of FIG. 7.

The key-information detection section 21 judges whether an operation for starting the analysis has been performed by the user (ST703). Specifically, the key-information detection section 21 detects key information that is input when the user presses a predetermined button (button for instructing the start of analysis).

The content retrieval section 22 acquires the detected key information and starts to retrieve unanalyzed contents from the audio file D1 that is contained in the content list 41 (ST704). Specifically, the content retrieval section 22 acquires the attribute data contained in the audio file D1 of the content list 41, which is shown in FIG. 3, and judges whether the audio file D1 has already been analyzed, based on the analysis flag in the attribute data.

The content retrieval section 22 calculates the number of unanalyzed contents, a remaining analysis time that is a remaining time necessary for the analysis of the unanalyzed contents, and the like, and causes a display screen to display the number of unanalyzed contents and the remaining analysis time as shown in FIG. 9 (ST705). The remaining analysis time is analyzed based on a sum of the lengths of respective contents, for example. FIG. 9 is a diagram showing the number of unanalyzed contents and the remaining analysis time. During analysis of a content, as shown in FIG. 9, the number of already-analyzed pieces/the number of unanalyzed pieces (4/60), the remaining analysis time (1 minutes 23 seconds), and the like are displayed on the display screen together with the message indicating that the analysis is in process, for example.

The content retrieval section 22 judges whether there is an unanalyzed content as in ST701 (ST706). It should be noted that in a case where the processing of ST706 is first performed, it has already been judged in ST701 that an unanalyzed content is present. Therefore, the processing of ST706 can be omitted. When there are no unanalyzed contents (NO in ST706), the content retrieval section 22 terminates the analysis and classification processing.

When an unanalyzed content is present (YES in ST706), the content group management section 26 refers to the content list of the audio file D1 shown in FIG. 3 to judge whether the audio file D1 is registered in a specific group (ST707). When it is judged that the audio file D1 is registered in a specific group (YES in ST707), the processing returns to ST705 and the content group management section 26 calculates the number of unanalyzed contents and the remaining analysis time and displays the calculation results. When the content group management section 26 judges that the audio file D1 is not registered in a specific group (NO in ST707), the processing proceeds to ST708.

The content group management section 26 judges whether the audio file D1 is an audio content (ST708). The audio content includes materials of English conversation or the like, news, audio generated by merely reading a book, and the like. Whether the audio file D1 is an audio content is judged based on the presence/absence of a character string such as “Podcast”, “Language”, “News”, “Audio Book”, or “Talk” in the attribute information of the audio file D1. When judging that such a character string is contained in the attribute information (YES in ST708), the content group management section 26 judges that the content is an audio content, and when judging that such a character string is not contained in the attribute information (NO in ST708), it judges that the content is not an audio content.

When the content group management section 26 judges that the audio file D1 is an audio content (YES in ST708), the processing returns to ST705 and the content group management section 26 calculates the number of unanalyzed contents and the remaining analysis time and displays the calculations results. When the content group management section 26 judges that the audio file D1 is not an audio content (NO in ST708), the processing proceeds to ST709. That is, when the content is unanalyzed (YES in ST706), is not registered in a group (NO in ST707), and is not an audio content (NO in ST708), the analysis and classification processing of the content is executed in ST709 and subsequent steps.

The content analysis section 25 acquires the attribute data of the audio file D1 that is stored in the content database 23 and then acquires the entire content length c from the attribute data of the audio file D1 (ST709).

The content analysis section 25 calculates the analysis time interval K of the audio file D1 (analysis start position and analysis end position) using an analytical formula database, based on the table of analytical formula data shown in FIG. 5 (ST710).

The content analysis section 25 sets an equalizer to be off (ST711).

The content decode section 24 decodes the audio file D1 (ST712).

The content analysis section 25 uses data decoded in the content decode section 24 to analyze the music tone of the audio file D1 in the analysis time interval K as described above (ST713). With this analysis, a characteristic amount for classifying the audio file D1 into a group is obtained.

After that, the content analysis section 25 returns the setting of the equalizer (ST714).

Based on the characteristic amount obtained from the content analysis section 25, the content group management section 26 judges a group to which the audio file D1 is to belong, and updates a group management table that is registered in the content group management database 27 using the judgment result (ST715).

Then, the processing returns to ST705, and the calculation of the number of unanalyzed contents and the remaining analysis time and the display of the calculation results are repeated. When judging that there are no unanalyzed contents in ST706, the content analysis section 25 terminates the analysis classification processing.

### (Reproduction by Reproducing Apparatus 1)

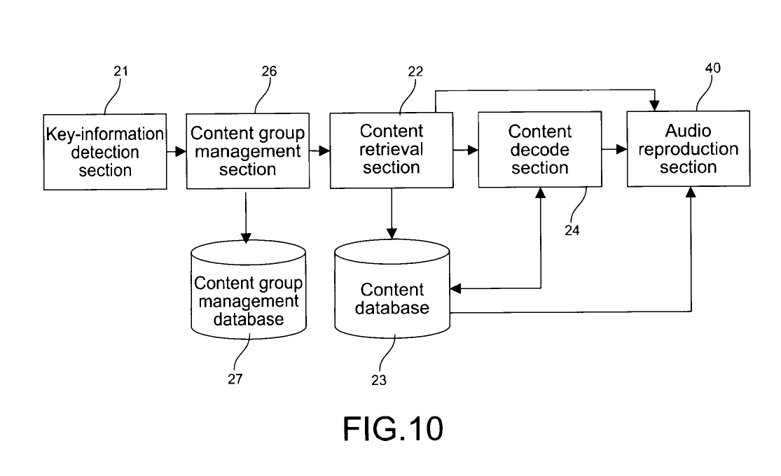

FIG. 10 is a block diagram showing a functional configuration at a time of reproduction in the reproducing apparatus 1.

Hereinafter, it is assumed that a user selects a channel that is capable of continuously reproducing contents of an even music tone (within the same group) (Omakase Channel ((registered trademark)) and the user can select a desired group from the group list 42 as shown in FIG. 4.

The key-information detection section 21 detects the key information that is input by the user and transmits it to the content group management section 26. Specifically, in the key-information detection section 21, Relaxing G1 is selected by the user, for example, from the groups shown in FIG.4. Then, based on the information indicating the group selected by the user, the content group management section 26 extracts information indicating audio files that belong to the selected group from the group list 42 contained in the content group management database 27, and notifies the information to the content retrieval section 22.

The content retrieval section 22 retrieves corresponding audio files from the content database 23 based on the information notified by the content group management section 26. The content retrieval section 22 selects an audio file to be decoded from the retrieved audio files and transmits information of the selected audio file, for example, information such as a file name, to the content decode section 24.

The content decode section 24 acquires audio data of the corresponding audio file from the content database 23 based on the information of the audio file that is notified by the content retrieval section 22, and decodes the audio data.

An audio reproduction section 40 acquires the decoded audio data from the content decode section 24 and the entire content length c described in the attribute data contained in the audio file to be reproduced, and then calculates the reproduction start position P from the entire content length c. Then, the audio reproduction section 40 reproduces the audio data from the reproduction start position P that is associated with the analysis time interval K.

(Reproduction Operation performed by Reproducing Apparatus 1)

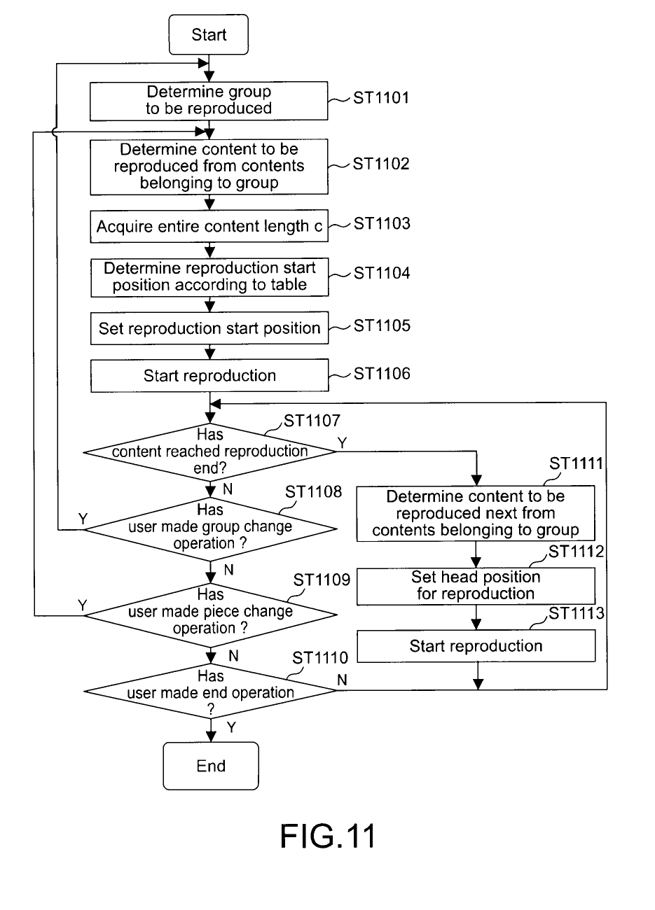

FIG. 11 is a flowchart of a content data reproduction operation of the reproducing apparatus 1. Hereinafter, it is assumed that a user can select a desired group from a plurality of groups (G1 to G5 etc.) shown in FIG. 4.

First, the user operates the key input section 7 to perform an input operation for selecting a group to be reproduced. The key-information detection section 21 outputs a key code that corresponds to the input from the key input section 7 to the content group management section 26. The content group management section 26 determines the group selected by the user based on the key code that is input from the key-information detection section 21 and notifies the content retrieval section 22 of file names of audio files that belong to the group (ST1101).

The content retrieval section 22 determines a file name of an audio file to be reproduced first, from the file names of the audio files notified by the content group management section 26, for example, at random. The content retrieval section 22 then notifies the decided file name to the audio reproduction section 40 and the content decode section 24 (ST1102).

Based on the file name notified by the content retrieval section 22, the audio reproduction section 40 acquires an entire content length c that is contained in the attribute data of the corresponding audio file from the content database 23 (ST1103).

Based on the acquired entire content length c, the audio reproduction section 40 calculates a reproduction start position P using the table of analytical formula data shown in FIG. 5 (ST1104).

The audio reproduction section 40 sets the calculated reproduction start position P calculated in ST1104 as a reproduction start position of the audio data (ST1105).

Accordingly, the audio reproduction section 40 starts the reproduction processing from a position that corresponds to the reproduction start position P of the audio data (ST1106).

The audio reproduction section 40 judges whether the reproduction of the audio file is finished (ST1107).

When the reproduction of the audio data is not finished (NO in ST1107), the audio reproduction section 40 judges, based on the key code input from the key-information detection section 21, whether the user has made a group change operation (ST1108).

If the user has made the group change operation (YES in ST1108), the processing returns to ST1101 and the audio reproduction section 40 newly determines a group to be reproduced.

If the user has not made the group change operation (NO in ST1108), the processing proceeds to ST1109.

The audio reproduction section 40 judges whether the user has made an operation for changing an audio data to be reproduced based on the key code input from the key-information detection section 21 (ST1109).

If the user has made the operation for changing an audio data to be reproduced (YES in ST1110), the processing returns to ST1102 and the audio reproduction section 40 determines an audio file to be reproduced. Accordingly, an audio file to be reproduced is changed for another audio file in the same group.

If the user has not made the operation for changing an audio data to be reproduced (NO in ST1109), the audio reproduction section 40 judges whether the user has made an end operation based on the key code input from the key-information detection section 21 (ST1110).

If the user has made the end operation (YES in ST1110), the audio reproduction section 40 terminates the reproduction processing. If the user has not made the end operation (NO in ST1110), the processing return to ST1107 and the audio reproduction section 40 judges whether the reproduction of the audio file is finished.

When the reproduction of the audio data is finished (YES in ST1107), the audio reproduction section 40 determines a content to be reproduced next from contents belonging to the group (ST1111). Specifically, when the reproduction of the audio data is finished, the audio reproduction section 40 determines, from audio files contained in the same group as the audio file, an audio file to be reproduced next at random. It should be noted that, when the reproduction of the audio file is finished, audio files in the same group may be reproduced in the order of being in the list, as shown in FIG. 4.

The audio reproduction section 40 sets a head position of audio data of an audio file to be reproduced next as a reproduction start position (ST1112).

The audio reproduction section 40 starts reproducing the audio data (ST1113), and the processing returns to ST1107 so that the audio reproduction section 40 judges whether the reproduction of the audio file is finished.

### (Operation)

As described above, according to this embodiment, because the reproducing apparatus 1 judges the analysis time interval K for the audio data based on the entire content length c (ST710), and analyzes the audio data in the analysis time interval K based on the judgment result, a calculation load on the CPU 2 of the reproducing apparatus 1 can be reduced and an efficient analysis can be performed. Because the audio data that belongs to the group (classification item) selected by the key input section 7 is reproduced from the reproduction start position P within the analysis time interval K, the reproduction start position P is included in the analysis time interval K, with the result that it is possible to prevent the user from feeling uncomfortable with the analysis result.

In other words, in the case of the audio file, for example, an overall music tone of a music piece can be inferred from a part thereof without analyzing the music tone of the audio file over the entire content length c. As a result, the music tone only within the analysis time interval K is analyzed and the resultant is set to the music tone of the entire audio file, with the result that an efficient analysis of the music tone can be performed.

At this time, if an impression that a user gets in listening to the music piece is different from the analyzed classification result, the user feels uncomfortable with the analysis result. In this embodiment, the reproduction start position P is included in the analysis time interval K as shown in FIG. 5, which prevents the user from feeling uncomfortable with the analysis result at the time of starting reproduction.

Here, the reproduction start position P is not a head of the music piece but a specific position in a midstream of the music piece as shown in FIG. 6. The head of the music piece may be silent or an introduction portion in many cases, and hence the music tone of the music piece is difficult to be grasped quickly when the music piece is reproduced from the head thereof. Accordingly, it is desirable to reproduce a music piece from a position of a chorus thereof.

When judging that the entire content length c is equal to or larger than a predetermined value (for example, T) (see FIG. 5), the reproducing apparatus 1 judges a part of the entire content length c to be the analysis time interval K. Accordingly, when the entire content length c is equal to or larger than the predetermined value T, it is possible to set part of the audio data as the analysis time interval K, and to reduce a calculation load on the reproducing apparatus 1.

As shown in FIG. 5, for example, the reproducing apparatus 1 can make the reproduction start position P equivalent to an analysis start point of the analysis time interval K. Accordingly, it is possible to prevent the user from feeling uncomfortable with the analysis result more reliably at the time of reproducing the audio data.

When the unanalyzed audio files are stored, the reproducing apparatus 1 can display the message 32 for prompting the user to analyze the unanalyzed audio files, the message 32 being shown in FIG. 8. Accordingly, the user can be prompted to analyze the unanalyzed audio files.

The reproducing apparatus 1 can display the number of unanalyzed contents and the remaining analysis time on the display screen during the analysis (ST713 etc.) as shown in FIG. 9 (ST705). Accordingly, the user can know the number of audio files and a time period necessary to finish the processing of analysis and classification of audio data during the processing.

For example, the audio file D1 contains the analysis flag that is judgment information indicating whether the audio data has been analyzed. The reproducing apparatus 1 can judge whether the audio file D1 is to be analyzed based on the analysis flag. For example, in a case where the audio file D1 has been analyzed by an external apparatus, the reproducing apparatus 1 does not perform the analysis processing and the classification processing. For example, in the case where the audio file D1 has been analyzed by an external apparatus, the audio data of the audio file D1 and the characteristic amount that is an analysis flag or analysis result are associated with each other in advance and are stored in the audio file D1. Accordingly, in a case where an audio file is already analyzed in advance (in a case where audio data is associated with an analysis result in advance), the analysis processing and the classification processing are not performed, with the result that a calculation load on the CPU 2 can be reduced.

The reproducing apparatus 1 can set the reproduction start position P to a predetermined time point within the analysis time interval K (midpoint of the analysis time interval K) as shown in FIG. 5, and reproduce audio data for a predetermined period of time (fixed analysis length T) starting from the predetermined time point within the analysis time interval K (midpoint of the analysis time interval K), with result that it is possible to analyze audio data at a chorus position and reproduce the audio data.

If it is known in advance where is a chorus position as the climax of a music piece, the analysis time interval K is determined ahead of the reproduction start position P. In this case as well, for example, the reproduction start position P can be matched with the analysis time interval K by using the table of analytical formula data.

### (Modification)

A reproducing apparatus in a modification will be described next. It should be noted that in the following description, the same members and the like as those of the above-mentioned embodiment are denoted with the same reference numerals, and only difference therebetween will be described.

In the above embodiment, the reproduction start position P is obtained using Example 1 of the table of analytical formula data shown in FIG. 5. This modification is different from the above embodiment in that a reproduction start position P is obtained using Example 2 of the table of analytical formula data shown in FIG. 5.

As shown in FIG. 5, the analysis time interval K and the reproduction start position P are stored in the table of analytical formula data in accordance with four cases (1) to (4) of an entire content length c.

(1) When the entire content length c satisfies 0≦c<T, the analysis time interval K of a content is 0 to c, and the reproduction start position P thereof is 0.

(2) When the entire content length c satisfies T≦c<2T, the analysis time interval K of a content is c−T to c, and the reproduction start position P thereof is c−T.

(3) When the entire content length c satisfies 2T≦c<2S, the analysis time interval K of a content is c/2 to c/2+T, and the reproduction start position P thereof is c/2.

(4) When the entire content length c satisfies 2S≦c, the analysis time interval K of a content is S to S+T, and the reproduction start position P thereof is S.

As shown in FIG. 5, for example, the reproducing apparatus can make the reproduction start position P equivalent to an analysis start point of the analysis time interval K. Accordingly, it is possible to prevent the user from feeling uncomfortable with the analysis result more reliably at the time of reproducing audio data.

The present invention is not limited to the embodiment described above, and various modifications thereof can be made.

The present application contains subject matter related to that disclosed in Japanese Priority Patent Application JP 2008-219061 filed in the Japan Patent Office on Aug. 28, 2008, the entire content of which is hereby incorporated by reference.

What is claimed is:

1. A reproducing apparatus, comprising:
a storage section to store a plurality of pieces of audio data;
a judgment section to judge, based on a length of each of the pieces of audio data stored in the storage section, an analysis time interval for each of the pieces of audio data;
an analysis section to analyze the audio data in the analysis time interval judged by the judgment section;
a classification section to classify the respective pieces of audio data into a plurality of predetermined classification items based on results of the analysis;
an input section to cause a user to select the classification item of the audio data to be reproduced; and
a reproduction section to reproduce the audio data belonging to the classification item selected by the input section from a reproduction start point within the analysis time interval.

2. The reproducing apparatus according to claim 1,
wherein, when the judgment section judges that the length of the audio data is equal to or larger than a predetermined value, the judgment section judges part of the length of the audio data as the analysis time interval.

3. The reproducing apparatus according to claim 2,
wherein the reproduction start point is equal to an analysis start point of the analysis time interval.

4. The reproducing apparatus according to claim 3, further comprising
a display section to display a guide screen for prompting a user to analyze unanalyzed audio data stored in the storage section.

5. The reproducing apparatus according to claim 4, further comprising
a control section to perform control so that processing performed by the judgment section, the analysis section, and the classification section are successively performed on the plurality of pieces of audio data stored in the storage section.

6. The reproducing apparatus according to claim 5,
wherein the control section performs control so that a remaining time of the processing on all the pieces of audio data stored in the storage section is calculated and displayed.

7. The reproducing apparatus according to claim 6,
wherein the analysis section analyzes a music tone of the audio data.

8. A reproducing method, comprising:
storing a plurality of pieces of audio data;
judging, based on a length of each of the pieces of audio data, an analysis time interval for each of the pieces of audio data;
analyzing the audio data in the judged analysis time interval;
classifying the respective pieces of audio data into a plurality of predetermined classification items based on results of the analysis;
causing a user to select the classification item of the audio data to be reproduced; and
reproducing the audio data belonging to the selected classification item from a reproduction start point within the analysis time interval.

9. A reproducing apparatus, comprising:
a storage means for storing a plurality of pieces of audio data;
a judgment means for judging, based on a length of each of the pieces of audio data stored in the storage means, an analysis time interval for each of the pieces of audio data;
an analysis means for analyzing the audio data in the analysis time interval judged by the judgment means;
a classification means for classifying the respective pieces of audio data into a plurality of predetermined classification items based on results of the analysis;
an input means for causing a user to select the classification item of the audio data to be reproduced; and
a reproduction means for reproducing the audio data belonging to the classification item selected by the input means from a reproduction start point within the analysis time interval.

10. A recording medium recording a program for executing:
storing a plurality of pieces of audio data;
judging, based on a length of each of the pieces of audio data, an analysis time interval for each of the pieces of audio data;
analyzing the audio data in the judged analysis time interval;
classifying the respective pieces of audio data into a plurality of predetermined classification items based on results of the analysis;
causing a user to select the classification item of the audio data to be reproduced; and
reproducing the audio data belonging to the selected classification item from a reproduction start point within the analysis time interval.
